(19) United States
(12) Patent Application Publication
(10) Pub. No.: US 2016/0373889 A1
(43) Pub. Date: Dec. 22, 2016

(54) LOCATION ACCURACY IMPROVEMENT METHOD AND SYSTEM USING NETWORK ELEMENTS RELATIONS AND SCALING METHODS

(71) Applicant: WEFIND - TECH.LTD,, Tel-Aviv (IL)

(72) Inventors: Ofer KLEIN, TEL-AVIV (IL); Joshua BARBASH, TEL AVIV (IL)

(73) Assignee: WEFIND-TECH LTD, TEL AVIV (IL)

(21) Appl. No.: 14/914,658

(22) PCT Filed: Aug. 21, 2014
(86) PCT No.: PCT/IL14/50750

§ 371 Date: Feb. 26, 2016

Related U.S. Application Data
(60) Provisional application No. 61/870,268, filed on Aug. 27, 2013.

(51) Int. Cl. H04W 4/02; H04W 4/00

(52) U.S. Cl. CPC H04W 4/02; H04W 4/008

(57) ABSTRACT

A self-learning location monitor system comprising: a. a plurality of N devices D, each device Dᵢ comprising a communication module configured to communicate with at least one other device D_{j≠i} within a predetermined rangeᵢ of device Dᵢ; the device Dᵢ may be characterized by a grade Gᵢ according to its accuracy of location; b. a location detection module configured to detect location of the N module devices; c. a non-transitory CRM in communication with the N devices; According to one embodiment the CRM is configured to change grade Gᵢ according to at least one other grade G_{j≠i} of at least one other device D_{j≠i} within range Rᵢ. According to another embodiment the instructions are to change range Rᵢ of at least one device Dᵢ located in other range R_{k≠i} of other device D_{k≠i} according to the other range R_{k≠i}.

### FIELD OF THE INVENTION

The present invention relates to the field of estimating location of an electronic device, more specifically, it focuses on the field of estimating using communication with other devices.

### BACKGROUND

Children, pets, people that require supervision (elderly persons, prisoners etc), important or valuable objects, and any object that is movable may be lost and apart from their intended location either by disorientation, distraction, theft or kidnapping. With the increased concern regarding the above there is a need for relatable and quick methods for tracking some or all of the above that will appropriately alert the relevant persons or authorities.

Conventional methods focuses on existing tracking modules constructed on devices, such as GPS, or by relating to an external module for assisting in detection of location.

There is therefore a long unmet need for a simple, easy to use system, which will be independent and be able to estimate the location of a device by other devices around it.

### SUMMARY OF THE INVENTION

It is one object of the present invention to provide a self-learning location monitor system comprising:
a. a plurality of N devices D, each device Dᵢ of the N devices comprising a communication module configured to communicate with at least one other device D_{j≠i} of the N devices within a predetermined range Rᵢ of the device Dᵢ; the device Dᵢ is characterized by a grade Gᵢ according to accuracy of location of the device Dᵢ;
b. a location detection module configured to detect location of at least one of the N devices;
c. a non-transitory computer readable medium (CRM) in communication with the N devices configured to receive the grade Gᵢ of each the device Dᵢ;
wherein the CRM is configured to change the grade Gᵢ according to at least one other the grade of at least one other the device D_{j≠i} within the range Rᵢ.

It is another object of the present invention to provide the system as defined above, wherein at least one the device Dᵢ of the N devices additionally comprising a module selected from a group consisting of: accelerometer, Bluetooth, WiFi, GPS, step counter, accuracy module, time movement, zigbee, short wave wireless, sub-giga RF transmitters and receivers, Dash7 (433 MGH) and a combination thereof.

It is another object of the present invention to provide the system as defined above, wherein at least one the device Dᵢ of the N devices is selected from a group consisting of: mobile device, wearable gadget, computer, laptop and tablet.

It is another object of the present invention to provide the system as defined above, wherein the grade Gᵢ is determined according to accuracy level of the location detection.

It is another object of the present invention to provide the system as defined above, wherein the CRM is located on a central server.

It is another object of the present invention to provide the system as defined above, wherein the CRM is integrated in at least one of the N devices.

It is another object of the present invention to provide the system as defined above, wherein the range Rᵢ and/or the grade Gᵢ, are time-dependent.

It is another object of the present invention to provide the system as defined above, wherein the range Rᵢ is determined by a triangulation method.

It is another object of the present invention to provide the system as defined above, wherein the range Rᵢ is determined by a reception range of a module integrated within the device Dᵢ.

It is another object of the present invention to provide a self-learning location monitor system comprising:
a. a plurality of N devices D, each device Dᵢ of the N devices comprising a communication module configured to communicate with at least one other device D_{k≠i} of the N devices within a predetermined range Rᵢ of the device Dᵢ;
b. a non-transitory computer readable medium (CRM) integrated in at least one of the N devices having instructions thereon;
wherein the instructions are to change the range Rᵢ of at least one the device Dᵢ of the N devices located in other the range R_{k≠i} of the other device D_{k≠i} according to the other range R_{k≠i}.

It is another object of the present invention to provide the system as defined above, wherein at least one the device Dᵢ of the N devices additionally comprising a module selected from a group consisting of: accelerometer, Bluetooth, WiFi, GPS, step counter, accuracy module, time movement, zigbee, short wave wireless, sub-giga RF transmitters and receivers, Dash7 (433 MGH) and a combination thereof.

It is another object of the present invention to provide the system as defined above, wherein at least one the device Dᵢ of the N devices is selected from a group consisting of: mobile device, wearable gadget, computer, laptop and tablet.

It is another object of the present invention to provide the system as defined above, wherein the CRM is located on a central server.

It is another object of the present invention to provide the system as defined above, wherein the range Rᵢ is time-dependent.

It is another object of the present invention to provide the system as defined above, wherein the range Rᵢ is determined by a triangulation method.

It is another object of the present invention to provide the system as defined above, wherein the range Rᵢ is determined by a reception range of a module integrated within the device Dᵢ.

It is another object of the present invention to provide a self-learning location monitor method comprising steps of:
a. providing a plurality of N devices D, each device Dᵢ of the N devices comprising a communication module;
b. communicating, by the communication module, between at least one device Dᵢ of the N devices and at least one other device D_{j≠i} of the N devices, within a predetermined range Rᵢ of the device Dᵢ;
c. characterizing each the device Dᵢ of the N devices by a grade Gᵢ according to accuracy of location of the device Dᵢ;
d. detecting location of at least one the device Dᵢ of the N devices using a location detection module;
e. receiving, by a non-transitory computer readable medium (CRM), the grade Gᵢ of each the device Dᵢ;
wherein the CRM is configured for changing the grade Gᵢ according to other the grade G_{j≠i} of at least one other the device D_{j≠i} within the range Rᵢ.

It is another object of the present invention to provide the method as defined above, wherein at least one the device Dᵢ of the N devices additionally comprising a module selected from a group consisting of: accelerometer, Bluetooth, WiFi, GPS, step counter, accuracy module, time movement, zigbee, short wave wireless, sub-giga RF transmitters and receivers, Dash7 (433 MGH) and a combination thereof.

It is another object of the present invention to provide the method as defined above, wherein at least one the device Dᵢ of the N devices is selected from a group consisting of: mobile device, wearable gadget, computer, laptop and tablet.

It is another object of the present invention to provide the method as defined above, wherein the step of characterizing the grade Gᵢ is according to accuracy level of the location detection.

It is another object of the present invention to provide the method as defined above, additionally comprising step of locating the CRM on a central server.

It is another object of the present invention to provide the method as defined above, additionally comprising step of integrating the CRM in at least one of the N devices Dᵢ.

It is another object of the present invention to provide the method as defined above, wherein the range Rᵢ and/or the grade Gᵢ are time-dependent.

It is another object of the present invention to provide the method as defined above, wherein the range Rᵢ is determined by a triangulation method.

It is another object of the present invention to provide the method as defined above, wherein the range Rᵢ is determined by a reception range of a module integrated within the device Dᵢ.

It is another object of the present invention to provide a self-learning location monitor method comprising steps of:
a. providing a plurality of N devices, each device Dᵢ of the N devices comprising a communication module;
b. communicating, by the communication module, between at least one the device Dᵢ of the N devices and at least one other the device D_{k≠i} of the N devices, within a predetermined range Rᵢ of the device Dᵢ,
c. providing a non-transitory computer readable medium (CRM) integrated in at least one of the N devices having instructions thereon;
wherein the instructions are for changing the range Rᵢ of at least one the device Dᵢ of the N devices located in other the range R_{k≠i} of at least one other the device D_{k≠i} of the N devices, according to the other range R_{k≠i}.

It is another object of the present invention to provide the method as defined above, wherein at least one the device Dᵢ of the N devices additionally comprising a module selected from a group consisting of: accelerometer, Bluetooth, WiFi, GPS, step counter, accuracy module, time movement, zigbee, short wave wireless, sub-giga RF transmitters and receivers, Dash7 (433 MGH) and a combination thereof.

It is another object of the present invention to provide the method as defined above, wherein at least one the device Dᵢ of the N devices is selected from a group consisting of: mobile device, wearable gadget, computer, laptop and tablet.

It is another object of the present invention to provide the method as defined above, additionally comprising step of locating the CRM on a central server.

It is another object of the present invention to provide the method as defined above, wherein the range Rᵢ is time-dependent.

It still an object of the present invention to provide the method as defined above, wherein the range Rᵢ is determined by a triangulation method.

It is lastly object of the present invention to provide the method as defined above, wherein the range Rᵢ is determined by a reception range of a module integrated within the device Dᵢ.

### BRIEF DESCRIPTION OF THE DRAWINGS

In order to understand the invention and to see how it may be implemented in practice, a few preferred embodiments will now be described, by way of non-limiting example only, with reference to be accompanying drawings, in which:

FIG. 1 describes a first self-learning location monitor system;

FIG. 2 discloses a first self-learning location monitor system;

FIG. 3 shows a first self-learning location monitor method; and

FIG. 4 shows a second self-learning location monitor method.

### DETAILED DESCRIPTION OF THE INVENTION

The following description is provided so as to enable any person skilled in the art to make use of the invention and sets forth examples contemplated by the inventor of carrying out this invention. Various modifications, however, will remain apparent to those skilled in the art, since the generic principles of the present invention have been defined specifically. Also, it is to be understood that the phraseology and terminology employed herein is for the purpose of description and should not be regarded as limiting.

The term “server”, refers hereinafter to any physical hardware adapted to communicate with electronic devices and store data. It may also relate to different disconnected hardware devices at different locations, these hardware devices maybe in partial or full communication with each other.

The term “computer readable medium (CRM)”, refers hereinafter to any non-transitory medium that is capable of storing or encoding a sequence of instructions for execution by a computer and that cause the computer to perform any one of the methodologies of the present invention, it includes, but is not limited to, solid-state memories, optical and magnetic disks, and carrier wave signals.

The term “sub-giga RF” refers hereinafter to radio frequency below 1000 KHz.

The term “Dash7” refers hereinafter to an open source wireless sensor networking standard for wireless sensor networking.

The term “Bluetooth” refers hereinafter to a wireless technology standard for exchanging data over short distances (using short-wavelength radio transmissions in the ISM band from 2400-2480 MHz) from fixed and mobile devices.

The term “WiFi” refers hereinafter to the technology that allows an electronic device to exchange data or connect to the internet wirelessly using radio waves.

The term “GPS” refers hereinafter to a space-based satellite navigation system that provides location and time information in all weather conditions, anywhere on or near the Earth where there is an unobstructed line of sight to four or more GPS satellites.

The term “zigbee” refers hereinafter to a suite of high level communication protocols used to create personal area networks built from small, low-power digital radios.

It is one object of the present invention to provide a first self-learning location monitor system comprising:
a. a plurality of N devices D, each device Dᵢ of the N devices comprising a communication module configured to communicate with at least one other device D_{j≠i} of the N devices within a predetermined range Rᵢ of the device Dᵢ; each device Dᵢ of the N devices is characterized by a grade Gᵢ according to accuracy of the location of the device Dᵢ;
b. a location detection module configured to detect location of at least one of the N devices;
c. a non-transitory computer readable medium (CRM) in communication with the N devices configured to receive the grade Gᵢ of each device Dᵢ;
   wherein the CRM is configured to change grade Gᵢ according to at least one other grade G_{j≠i} of at least one other device D_{j≠i} within the range Rᵢ.

It is one object of the present invention to provide a second self-learning location monitor system comprising:
a. a plurality of N devices D, each device Dᵢ of the N devices comprising a communication module configured to communicate with at least one other device D_{k≠j} of the N devices, within a predetermined range Rᵢ of device Dᵢ;
b. a non-transitory computer readable medium (CRM) integrated in at least one of the N devices having instructions thereon;
   wherein the instructions are to change the range Rᵢ of at least one device Dᵢ of the N devices located in range R_{k≠j} of other device D_{j≠i}, according to the other range R_{k≠i}.

It is one object of the present invention to disclose a first self-learning location monitor method comprising steps of:
a. providing a plurality of N devices D, each device Dᵢ of the N devices comprising a communication module;
b. communicating, by the communication module, between at least one device Dᵢ of the N devices and at least one other device D_{j≠i} of the N devices, within a predetermined range Rᵢ of device Dᵢ;
c. characterizing each device Dᵢ of the N devices by a grade Gᵢ according to accuracy of location of device Dᵢ;
d. detecting location of at least one device Dᵢ of the N devices using a location detection module;
e. receiving, by a non-transitory computer readable medium (CRM), grade Gᵢ of each device Dᵢ;
wherein the CRM is configured for changing grade Gᵢ according to other grade G_{j≠i} of at least one other device D_{j≠i} within range Rᵢ.

It is one object of the present invention to disclose a second self-learning location monitor method comprising steps of:
a. providing a plurality of N devices, each device Dᵢ of the N devices comprising a communication module;
b. communicating, by the communication module, between at least one device Dᵢ of the N devices and at least one other device D_{k≠i} of the N devices, within a predetermined range Rᵢ of device Dᵢ,
c. providing a non-transitory computer readable medium (CRM) integrated in at least one of the N devices having instructions thereon;
wherein the instructions are for changing range Rᵢ of at least one device Dᵢ of the N devices located in other range R_{k≠i} of at least one other device D_{k≠i} of the N devices, according to other range R_{k≠i}.

The need for an accurate location detection of elements is increasing, while not every element is equipped in very accurate location sensors, or in a position or area, and where its location accuracy is not good enough.

Instead of installing new, more accurate infrastructure, the concept of this invention is to enhance the accuracy of elements in the network by using the information of relation to other elements, such as distance and direction and by providing scales according to sensors status on each device and information history.

The accuracy of each element can be improved by the more high accuracy elements which are in the network and along the time.

High accuracy elements in the network are used as anchors, on which elements with lower accuracy level can rely, if nearby, in order to improve their accuracy

The current invention provides a system in various embodiments, which enables improvement of location detection in a network of electronic devices. The electronic devices, can be used as a host for an application, such as a smartphone; it can also be a designated device constructed especially for this purpose, for example, a wearable gadget.

A plurality of such devices (each may be different), are randomly distributed in some area. Some of the devices have the ability to locate another device. Each device has some communication module with a certain range, this range may be constant or it may be time dependent. It maybe adjustable by a user or it may come as a parameter which the user is not able to control.

The purpose of the current invention is to get an estimation of the quality of location detection of the device. This estimation is done in two stages:
(i) the first stage requires grading each of the devices according to its own parameters; that is, for example, if a device has a GPS (which is a device with high accuracy), it will receive a high grade; or if a device is static, it will also be a sign of good accuracy;
(ii) following the grading of each device, the communication between the devices is now used in order to change the grades which were set in stage (i); for example, if a device is identified in a certain range of another device (or plurality of devices), it may give further indication to the location of the devices in range; therefore, according to the grades of one of the devices, the grade of the other devices may change and vice versa.

At the end of the process, we have a dynamic, time-dependent network of electronic device, each having a location mark, and a quality grade attached to this mark. This system may work in two different modes:
(i) an independent mode—in which none of the devices communicate with an external module, they can all be in a closed area with no external communication mean. The grading can be done by all of the devices, one of them or some of them;
(ii) a connected mode—in which at least one device is connected to some external server; this external server maybe for computing the grades, or it may be for detecting location of at least one device.

The system as described, is constantly improving as more and more users are communicating with the devices. It may serve as an independent network for detecting location of devices providing its coverage is wide and accurate enough.

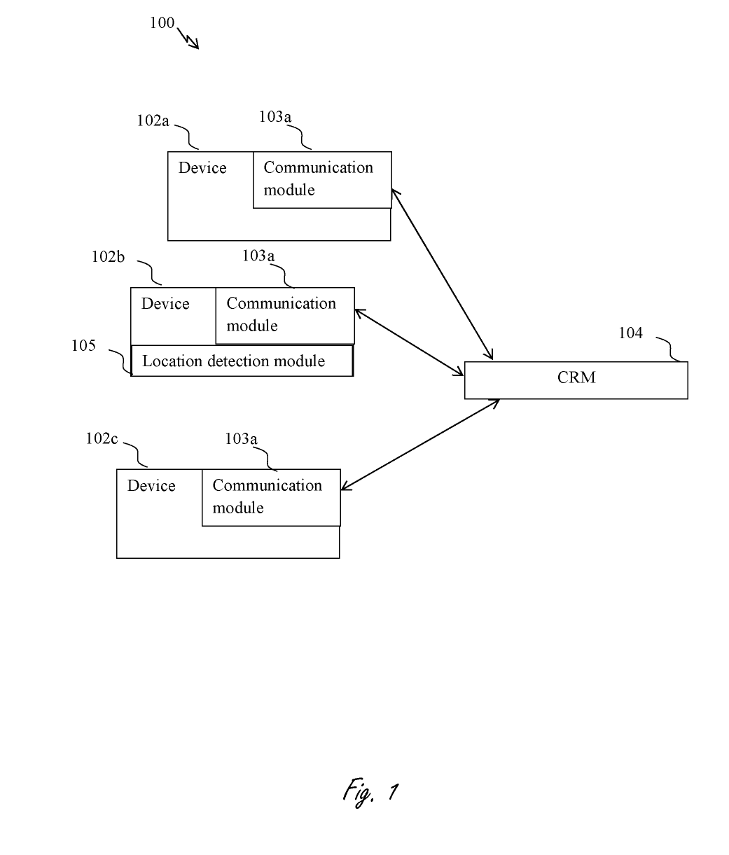

Reference is now made to FIG. 1 illustrating in a non-limiting manner a first self-learning location monitor system 100 comprising:
a. a plurality of N devices D 102a-c, each device Dᵢ comprising: a communication module 103a-c (respectively) configured to communicate with at least one of the N devices within a predetermined range Rᵢ of device Dᵢ,
   each device Dᵢ is characterized by a grade Gᵢ according to accuracy of the location of the device Dᵢ;
b. a location detection module 105 configured to detect location of at least one device 102b of the N devices;
c. a non-transitory computer readable medium (CRM) 104 in communication with the N devices 102a-c configured to receive the grade Gᵢ of each device Dᵢ;
   wherein the CRM 104 is configured to change grade Gᵢ according to at least one other G_{j≠i} of other device D_{j≠i} within range Rᵢ.

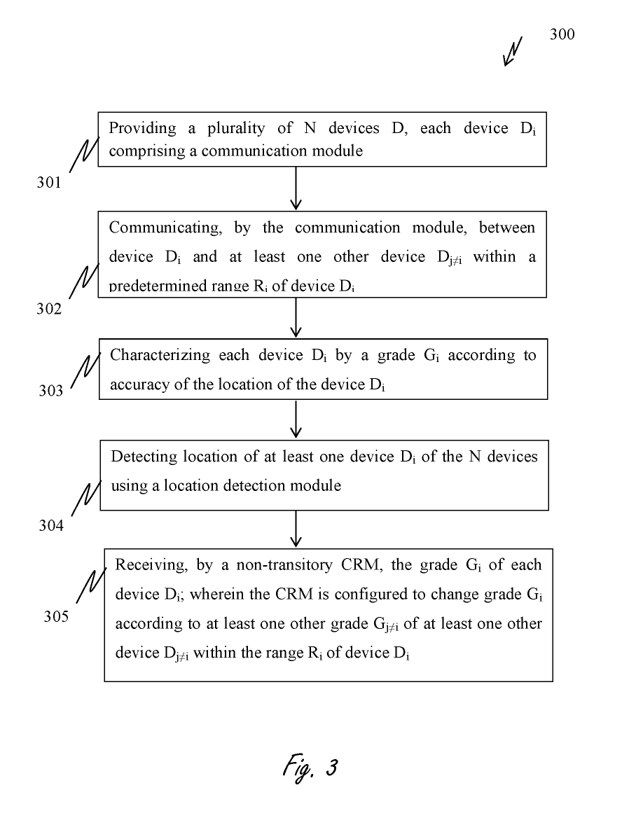

Reference is now made to FIG. 3 illustrating in a non-limiting manner a first self-learning location monitor method comprising:
a. step 301 of providing a plurality of N devices D, with each device Dᵢ comprising a communication module;
b. step 302 of communicating, by the communication module, between device Dᵢ and at least one other device D_{j≠i} of the N devices within a predetermined range Rᵢ of device Dᵢ;
c. step 303 of characterizing each device Dᵢ by a grade Gᵢ according to accuracy of the location of device Dᵢ;
d. step 304 of detecting location of at least one of the N devices using a location detection module;
e. step 305 of receiving by a non-transitory computer readable medium (CRM) the grade Gᵢ of each device Dᵢ;
wherein the CRM is configured to change grade Gᵢ according to at least one other grade of other device D_{j≠i} within range Rᵢ.

In one embodiment of the current invention, the first system or method as described above, wherein at least one device of the N devices additionally comprising a module selected from a group consisting of: accelerometer, Bluetooth, WiFi, GPS, step counter, accuracy module, time movement, zigbee, short wave wireless, sub-giga RF transmitters and receivers, Dash7 (433 MGH), and a combination thereof.

In one embodiment of the current invention, the first system or method as described above, wherein at least one device of the N devices is selected from a group consisting of: mobile device, wearable gadget, computer, laptop, tablet.

In one embodiment of the current invention, the first system or method as described above, wherein the grading is according to accuracy level of the location detection.

In one embodiment of the current invention, the first system or method as described above, wherein the CRM is located on a central server.

In one embodiment of the current invention, the first system or method as described above, wherein the CRM is integrated in at least one of the N devices.

In one embodiment of the current invention, the first system or method as described above, wherein range Rᵢ and/or grade Gᵢ are time-dependent.

In one embodiment of the current invention, the first system or method as described above, wherein range Rᵢ is determined by a triangulation method.

In one embodiment of the current invention, the first system or method as described above, wherein range Rᵢ is determined by a reception range of a module integrated within device Dᵢ.

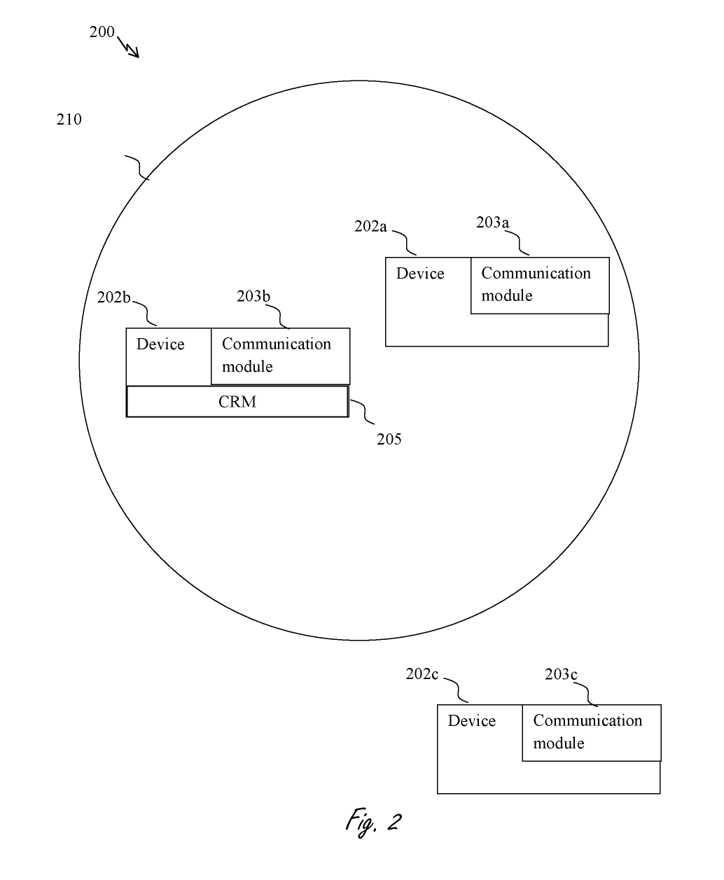

Reference is now made to FIG. 2 illustrating in a non-limiting manner, a second self-learning location monitor system comprising:
a. a plurality of N devices 202a-c, with each device Dᵢ comprising a communication module 203a-c (respectively) configured to communicate with at least one other device _{k≠i} of the N devices 202a-c within a predetermined range Rᵢ 210 of device Dᵢ,
b. a non-transitory computer readable medium (CRM) 205 integrated in at least one of the N devices 202b having instructions thereon;
wherein the instructions are for changing range Rᵢ of device Dᵢ located in other range R_{k≠i} of other device D_{k≠i} according to range R_{k≠i}.

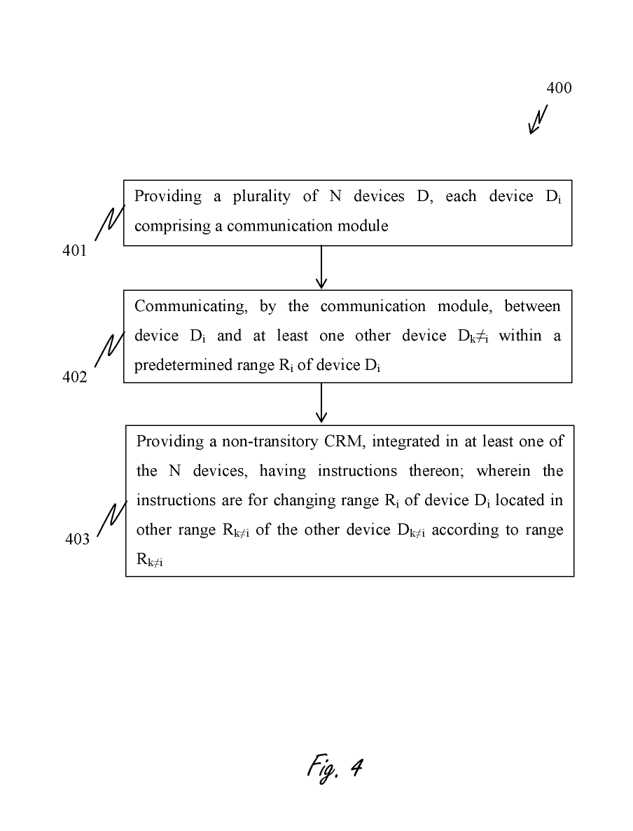

Reference is now made to FIG. 4, illustrating in a non-limiting manner, a second self-learning location monitor method comprising:
a. step 401 of providing a plurality of N devices D, each device Dᵢ comprising a communication module;
b. step 402 of communicating, by the communication module, between each device Dᵢ and at least one other device D_{k≠i} of the N devices, within a predetermined range Rᵢ of device Dᵢ,
c. step 403 of providing a non-transitory computer readable medium (CRM) integrated in at least one of the N devices having instructions thereon;
wherein the instruction are for changing range Rⱼ of device Dⱼ located in other range R_{k≠i} of other device D_{k≠i} according to range R_{k≠i}.

In one embodiment of the current invention, the second system or method as described above, wherein at least one device of the N devices additionally comprising a module selected from a group consisting of: accelerometer, Bluetooth, WiFi, GPS, step counter, accuracy module, time movement, zigbee, short wave wireless, sub-giga RF transmitters and receivers, Dash7 (433 MGH), and a combination thereof.

In one embodiment of the current invention, the second system or method as described above, wherein at least one device of the N devices is selected from a group consisting of: mobile device, wearable gadget, computer, laptop, tablet.

In one embodiment of the current invention, the second system or method as described above, wherein the CRM is located on a central server.

In one embodiment of the current invention, the second system or method as described above, wherein range Rᵢ is time-dependent.

In one embodiment of the current invention, the second system or method as described above, wherein range Rᵢ is determined by a triangulation method.

In one embodiment of the current invention, the second system or method as described above, wherein range Rᵢ is determined by a reception range of a module integrated within device Dᵢ.

### Example 1

In one example of the current invention, five mobile devices are inside a shopping a mall. No external communication is available; however, four of the devices have a Bluetooth with a range of 5 meters, and the fifth device has a Wifi with a range of 10 meters. Once the device with the WiFi enters the range of a first device with a Bluetooth, the device with the WiFi changes the range of its location to be within 5 meters away from the first device.

### Example 2

In another example of the current invention, three devices are located outdoors:

Device no. 1—is static according to its GPS for the last 10 minutes, and has grade G=100.
Device no. 2—is moving, it does not have a GPS, but it has Wifi, and has grade G=80.
Device no. 3—is also moving and is communicating via Bluetooth with device no. 2, and has grade G=50.

All of the devices are sending their grades to a cloud server, the cloud server receives a notification that Device no. 3 is also within the Bluetooth range of device No. 1, and therefore it increases the grade of device no. 3 from 50 to 76.

At a later stage, the server receives notification via the GPS of device No. 1, that device No. 1 is in motion; it therefore, reduces device's No. 1 grade from 100 to 90.

It will be appreciated by persons skilled in the art that embodiment of the invention are not limited by what has been particularly shown and described hereinabove. Rather the scope of at least one embodiment of the invention is defined by the claims below.

1. A system for determining direction of relative location comprising:
a. a first module configured to transmit radio signals;
b. a second module comprising:
i. a receiving module configured to receive said radio signals;
ii. a non-transitory computer readable medium in communication with said receiving module having instructions thereon for producing distance between said first module and said second module, from said radio signals; and
iii. a magnetometer configured to indicate relative direction of movement between said first module and said second module;
wherein said instructions are configured to determine direction of relative location of said first module, according to said relative direction and said distance.

2. The system according to claim 1, wherein
a. said second module additionally comprising a location module configured to determine location of said second module; and
b. said instructions are further for finding location of said first module according to said location of said second module.

3. (canceled)

4. The system according to claim 1, wherein said producing distance is according to data selected from a group consisting of: received signals strength indication (RSSI), received signals quality, time of data arrival (TOA) and beam forming.

5. The system according to claim 1, wherein
a. said first module additionally comprising a second receiving module;
b. said second module configured to transmit radio signals; and
c. said second module is configured to detect relative direction of movement of said first module.

6. (canceled)

7. (canceled)

8. The system according to claim 1, wherein said first module and/or said second module additionally comprising a device selected from a group consisting of: accelerometer, Bluetooth radio, WiFi radio, GPS, step counter, Gyro, Zigbee radio, Magnetometer and a combination thereof.

9. The system according to claim 1, wherein rate of emission of said radio signals is proportional to rate of location change of said first module.

10. The system according to claim 1, further comprising at least one additional said first module or at least one additional said second module.

11. (canceled)

12. The system according to claim 10, wherein rate of emission of said radio signals is proportional to density of one or more said first module and/or one or more said second module.

13. The system according to claim 10, wherein said relative direction is in respect to multiple said first module and/or multiple said second module.

14. The system according to claim 1, wherein
a. said first module is integrated in a device selected from a group consisting of: mobile device, wearable gadget, computer, laptop and tablet; and
b. said second module is integrated in a device selected from a group consisting of: mobile device, wearable gadget, computer, laptop and tablet.

15-18. (canceled)

19. A method for determining direction of relative location comprising steps of:
a. transmitting a radio signals form a first module;
b. providing a second module comprising:
(i) a receiving module;
(ii) a non-transitory computer readable medium having instructions thereon; and
(iii) a magnetometer;
c. receiving said radio signals by said receiving module;
d. producing distance between said first module and said second module, from said radio signals, according to said instructions; and
e. determining relative direction of movement between said first module and said second module using said magnetometer;
wherein said instructions are further for finding direction of relative location of said first module according to said relative direction and said distance.

20. The method according to claim 19, additionally comprising
a. step of providing said second module with a location module configured for determining location of said second module; and
b. step of finding location of said first module according to said location of said second module.

21. (canceled)

22. The method according to claim 19, wherein said producing distance is according to data selected from a group consisting of: Received signals strength indication (RSSI), Received Signals Quality, time of data arrival (TOA) and beam forming.

23. The method according to claim 19, additionally comprising
a. step of providing said first module with a second receiving module;
b. step of transmitting a radio signals form said second module; and
c. step of detecting relative direction of movement of said first module by said second module.

24. (canceled)

25. (canceled)

26. The method according to claim 19, additionally comprising step of providing said first module and/or said second module with a device selected from a group consisting of: accelerometer, Bluetooth radio, WiFi radio, GPS, step counter, Gyro, Zigbee radio, Magnetometer and any combination thereof.

27. The method according to claim 19, wherein rate of emission of said radio signals is proportional to rate of location change of said first module.

28. The method according to claim 19, additionally comprising step of proving at least one additional said first module or the step of proving at least one additional said second module.

29. (canceled)

30. The method according to claims 28 and/or 29, wherein rate of emission of said radio signals is proportional to density of one or more said first module and/or one or more said second module.

31. The method according to claims 28 and/or 29, wherein said relative direction is in respect to multiple said first module and/or multiple said second module.

32. The method according to claim 19, additionally comprising
a. step of integrating said first module a device selected from a group consisting of: mobile device, wearable gadget, computer, laptop and tablet; and
b. step of integrating said second module in a device selected from a group consisting of: mobile device, wearable gadget, computer, laptop and tablet.

33-36. (canceled)
